(19) United States
(12) Patent Application Publication
(10) Pub. No.: US 2013/0271453 A1
(43) Pub. Date: Oct. 17, 2013

(54) METHOD AND SYSTEM FOR GENERATING A THREE-DIMENSIONAL USER-INTERFACE FOR AN EMBEDDED DEVICE

(71) Applicants: Arto Ruotsalainen, Espoo (FI); Tuomas Volotinen, Espoo (FI); Miika Sell, Espoo (FI); Lasse Lindqvist, Espoo (FI); Alexey Vlasov, Espoo (FI); Rauli Laatikainen, Espoo (FI); Jussi Lehtinen, Espoo (FI); Tero Koivu, Espoo (FI); Ville-Veikko Helppi, Espoo (FI)

(72) Inventors: Arto Ruotsalainen, Espoo (FI); Tuomas Volotinen, Espoo (FI); Miika Sell, Espoo (FI); Lasse Lindqvist, Espoo (FI); Alexey Vlasov, Espoo (FI); Rauli Laatikainen, Espoo (FI); Jussi Lehtinen, Espoo (FI); Tero Koivu, Espoo (FI); Ville-Veikko Helppi, Espoo (FI)

(73) Assignee: RIGHTWARE OY, Espoo (FI)

(21) Appl. No.: 13/978,156

(22) PCT Filed: Nov. 25, 2011
(86) PCT No.: PCT/FI2011/051047

§ 371 Date: Jul. 3, 2013

Related U.S. Application Data
(60) Provisional application No. 61/429,766, filed on Jan. 5, 2011.

(30) Foreign Application Priority Data
Oct. 20, 2011 (FI) PCT/FI2011/050920

(51) Int. Cl. G06T 15/00

(52) U.S. Cl. CPC G06T 15/005
USPC 345/419

(57) ABSTRACT

The present invention relates generally to a method and system for generating a three-dimensional user-interface on an embedded device or devices. The method of generating a three-dimensional user interface comprising the steps of importing an asset into an editor on a host device, allowing a user to graphically effect modifications within the editor, modifying at least one property of the asset independently of a user to optimize a three-dimensional generation of the asset on an embedded device, generate a binary output file of the modified asset, and outputting the binary file to a graphics engine. Wherein the graphics engine is operable to load and render files as at least a portion of a graphical user interface its embedded device. Additionally, there is described an ordering of data in the binary output file such that it is independent of a degree of significance of individually accessible data within said output file.

### FIELD OF THE INVENTION

This invention relates to a method and system for generating a three-dimensional user interface for at least one embedded device.

### BACKGROUND TO THE INVENTION

Within the field of application of the present invention, systems have been developed for the development and rendering of a graphical user-interface for use within a three-dimensional space on a mobile or wireless device.

However, it will be appreciated by those in the industry, that these known systems provide problems with regard to the implementation of the user-interface as well as its differentiation in the three-dimensional domain.

In particular, in terms of these known systems, when changes are effected to an object in a graphical user interface (GUI) on a two-dimensional plane the changes are not translated adequately in the three-dimensional space and the resultant object will therefore not be optimized for viewing in this space.

In view of the above, it will be appreciated that a user interface (UI) design tool is required which further reduces the dependency on software by separating the design tool and the software.

Furthermore, known systems provide problems for device manufacturers as it results in a lock-in effect, in terms of which the GUI is limited to use on a specific platform or version of an operating system.

In view of the above, it will be appreciated that a user interface (UI) design tool is required which is independent of software, especially in the early stages of development. Such a design tool will enable a UI application to be modified after it has been completed, without the user having to resort to effecting the modifications in the software code itself. In addition, such a design tool will enable UI execution without a physical end-device or a specific simulator in mind.

### SUMMARY OF THE INVENTION

An object of the invention is to provide a method and system for generating a three-dimensional user-interface on at least one embedded device.

According to a first aspect of the invention there is provided a method of generating a three-dimensional user interface for at least one embedded device, said method comprising the steps of:
importing at least one asset into an editor on a host device;
in response to graphically effecting modifications, within said editor, to at least one property of the asset for the three-dimensional user interface, modifying at least one property of said imported asset independently of a user of said host device, so as to optimize a three-dimensional generation of said asset on an embedded device within said editor;
generating a binary output file of said modified asset conforming to a predefined file naming convention; and
outputting said binary file to a graphics engine, said graphics engine being

operable to load and render said file as at least a portion of a graphical user interface on said embedded device prior to outputting said binary file,

wherein ordering of data in said binary output file is independent of a degree of significance of individually accessible data within said output file.

In an embodiment of the invention, the step of loading said binary file includes loading the binary file into said graphics engine within said editor independently of a degree of significance of individually accessible data within said output file, prior to outputting said binary file to said graphics engine.

In an embodiment of the invention, the step of rendering said modified asset includes rendering said asset within a three-dimensional user interface in said editor, prior to outputting said binary file to said graphics engine.

In another embodiment of the invention, said loading and rendering of said binary output file takes place by means of a predetermined application programming interface (API).

In an embodiment of the invention, said binary output file is rendered to either a virtual or a physical display. In this embodiment of the invention, said virtual display is provided in the form of a user interface, said user interface interacting in an identical manner to said physical display.

In an embodiment of the invention, said method further comprises the step of:
re-generating a binary output file of said further modified asset conforming to a predefined file naming convention.

In another embodiment of the invention, said predefined file naming convention includes at least one engine layer component identifying a graphics engine layer to which said binary file is to belong. In this embodiment of the invention, said file naming convention further includes an individual component identifying a non-version specific asset. In this embodiment, said predefined file naming convention of said asset is independent of a version of said asset. Further, in this embodiment of the invention, all of the versions of said assets have the same file name.

In an embodiment of the invention, said at least one asset is a three-dimensional asset. In this embodiment, a modification of said at least one asset in said editor, is a modification of only a first two dimensions of said three-dimensional asset. In this embodiment, a modification of said third dimension of said three-dimensional asset is a modification which is independent of a user of said device.

In a further embodiment of the invention, said at least one asset is selected from a group including: buttons, cursors, backgrounds, icons, tools, interactive figures, graphical objects and graphical representations of objects.

In an embodiment of the invention, said at least one property is selected from a group including: size, shape, colour, shading, movement, shadow, orientation, function, location, appearance, file byte size and asset name.

In a further embodiment of the invention, said binary output file is provided in the form of a set of files. In this embodiment, said set of files includes a configuration file, a standalone file and a list of patch files. In this embodiment, said configuration file is provided in a simple format and contains a number of file paths, each of said file paths being relative to a working directory of an application using said configuration file. In this embodiment of the invention, said method further comprises the step of: applying said list of patch files on top of said standalone file so as to create a data container, said data container being operable to be patched further.

In this embodiment, a patch file in said list of patch files is operable to add, replace and delete one or more assets from said standalone file. In this embodiment of the invention, said patch file is generated by exporting said standalone file, comparing said standalone file to a base file and saving any modifications to said standalone file into a patch file. Here, any temporary standalone data in said base file is discarded.

In a further embodiment of the invention, said method further comprises the step of: creating a unique version of a graphical user interface development project. In this embodiment, a unique data container is exported from each of a plurality of profiles. In this embodiment, a format of said exported data container is configurable to either a standalone format or a patch format. In certain embodiments of the invention, a standalone format comprises creating a separate file from each profile in said plurality of profiles whereas said patch format comprises using a base file and creating a separate configuration and patch file for each profile in said plurality of profiles.

According to a second aspect of the invention there is provided a system for generating a three-dimensional user interface for at least one embedded device, said system comprising:
a graphics design editor operable to create and customize a graphical user interface on an embedded device; and
a graphics generation engine including a plurality of layers, each of said plurality of layers being ranked in order from highest to lowest as follows: an application framework layer, a user layer, a core layer, and a system layer, each of said plurality of layers only being dependent on a layer immediately preceding said layer in rank.

According to a third aspect of the invention, there is provided a computer-readable medium having stored thereon a set of instructions for causing a computer system to perform the steps of any of the methods described herein.

According to a fourth aspect of the invention, there is provided a non-transitory computer readable medium having stored thereon programming for causing a processor of a host device to perform the steps of any of the methods described herein.

### BRIEF DESCRIPTION OF THE DRAWINGS

FIG. 1 shows a graphical representation of a system for generating a graphical user interface for an embedded device, in accordance with a first aspect of the invention;

FIG. 2 shows a graphical representation of an embodiment of a graphics generation engine, in accordance with the system of FIG. 1;

FIG. 3 shows a graphical representation of a memory manager and utilities manager of a graphics generation engine, in accordance with that depicted in FIGS. 1 and 2;

FIG. 4 shows a graphical representation of the properties, property relationship and material relationship of a graphics generation engine, in accordance with that depicted in FIGS. 1 and 2;

FIG. 5 shows a graphical representation of a scene graph, generated by the graphics generation engine, in accordance with that depicted in FIGS. 1 and 2;

FIG. 6 shows a graphical representation of a user interface and its relation to the scene graph of FIG. 5, in accordance with that depicted in FIGS. 1 and 2;

FIG. 7 shows a graphical representation of animation component relations, in accordance with that depicted in FIGS. 1 and 2; and

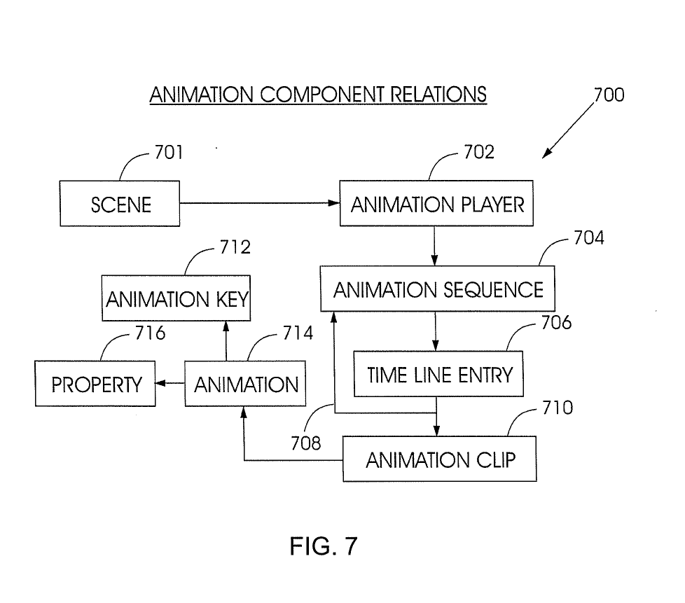

FIG. 8 shows a graphical representation of a method of generating a graphical user interface on an embedded device, in accordance with an embodiment of the invention.

### DETAILED DESCRIPTION OF EXEMPLARY EMBODIMENTS

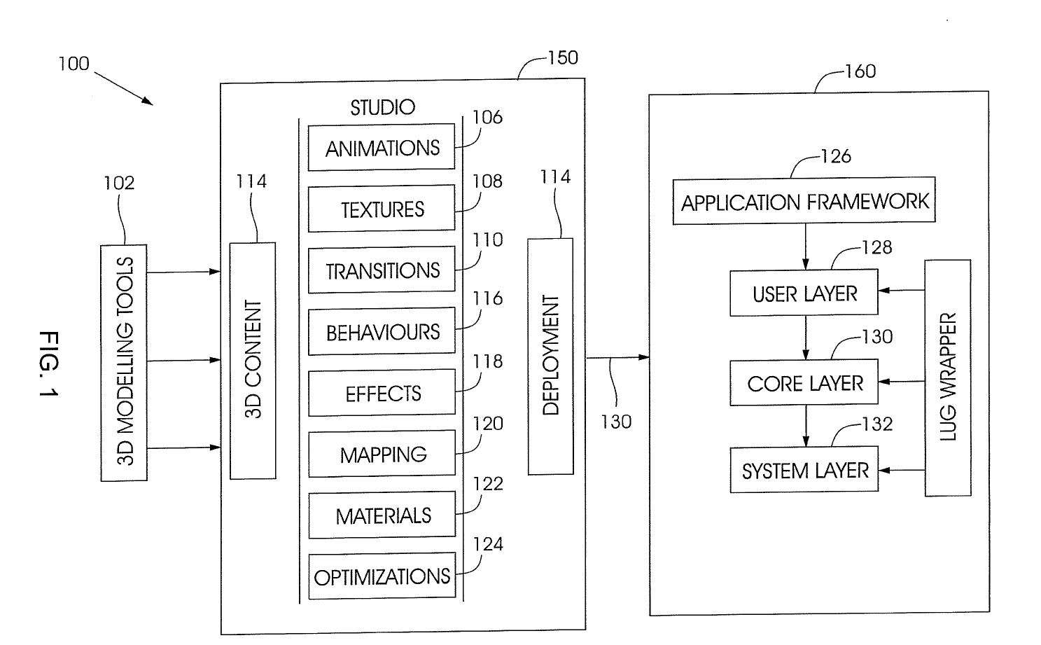

Referring to FIG. 1 of the drawings, a system for generating a graphical user interface for an embedded device is generally indicated by reference numeral 100.

The system 100 comprises a design studio 150 on a host device and a graphics engine 160 on a client or end device, the devices being in continuous or selective communication with each other through, for example, the interface 130. Three-dimensional modeling tools 102 feed into the design studio 150 which in turn feeds into the graphics engine 160.

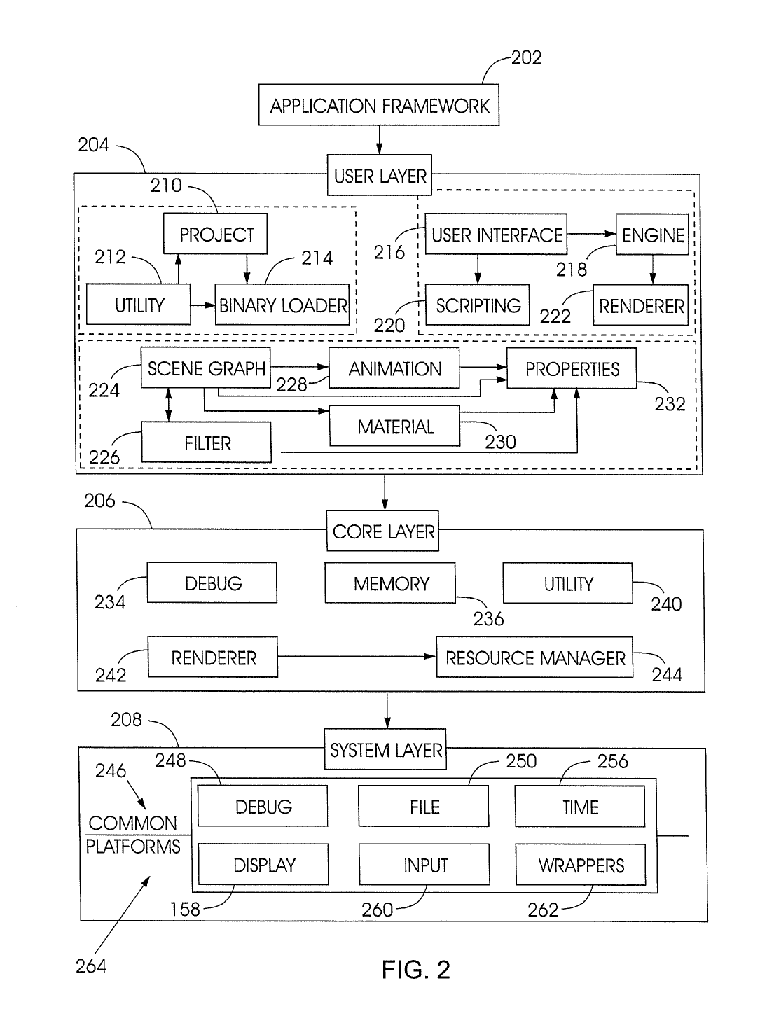

In this particular depiction of an embodiment of the invention, the system 100 is shown to include a design studio 150 and a graphics engine 160, each of which in more detail includes a plurality of functional components, the design studio 150 including an animation component 106, a textures component 108, a transitions component 110, a behaviors component 116, an effects component 118, a mappings component 120, a materials component 122 and an optimizations component 124. In practice, a design studio can omit one or more of the above mentioned components and/or can contain any number of additional components, substitute components or combination thereof. In turn, the graphics design engine 160 is divided into a number of different layers. The layers are preferably ordered such that each layer is dependent only on an immediately preceding lower-layer. The interaction between the various layers is described in more detail with reference to FIG. 2, further in the specification.

It is to be appreciated that the above functional components and layers may be consolidated onto one device or distributed among a plurality of devices in a conventional fashion. Each of these functional modules and layers are conceptual modules, the physical parameters of which may be operatively definable on a device or computer system during use, each of which corresponds to a functional task performed by the processor.

To this end, the system 100 includes a conventional machine-readable medium, e.g. a main memory, a hard disk, or the like, which carries thereon a set of instructions to direct the operation of the system 100 or the processor, for example being in the form of a computer program.

The design studio 150 provides a WYSIWYG (what-you-see-is-what-you-get) editor for the user interface designers and embedded engineers for the creation and customization of user interfaces (UIs), without the developer or designer having to self create or modify the programming code of the user interface (UI).

The graphics engine 160 enables UI designs to be easily executed on any device supporting graphics API, such as OpenGL ES 2.0, OpenGL ES 1.x, other versions of OpenGL, DirectX, or other know art recognized equivalents.

The interface 130 between the design studio 150 and the graphics engine 160 enables UI execution without physical end-device or specific simulator. The interface 130 is an application that renders the UI content to either a virtual or a physical display. All of the content data is preferably provided in a single file and the UI behaves identically compared to a physical device.

The interface 130 preferably produces as its output a single data file, which contains all of the assets created and configured in the project, as its output. This data can be used by various applications in the system 100 to render its content and execute logic and animations. Furthermore, said single data file can be one or more single sub-files of a standalone or master data file.

In this example embodiment, the data is exported as/to a single standalone file that contains all of the information. It is also possible to have a data source that is defined as a set of files containing a configuration file, a standalone file and a list of patch files. The configuration file is a file with a simple format containing a sequence of file paths, preferably one per line and starting with the standalone file. The paths are relative to the working directory of the application that uses the configuration file. The list of patch files can be applied on top of the standalone file, resulting in a data container that can be further patched. Patch files can add, replace and/or delete assets or substantial portions from a standalone file. Patch files are generated in the design studio 150 and then a new standalone file can be exported, compared against a base file, and any modifications to the base file are saved onto a patch file. Any temporary standalone data in the base file can then be discarded.

With reference to FIG. 2, the graphics engine 160 is divided into four different layers, namely the user layer 204, the core layer 206 and the system layer 208. The standard layer 208 provides the platform abstraction and wrappers for required libraries, such as the ANSI-C library, the OpenGL libraries or other known applicable art recognized equivalents.

Furthermore, presented herein is an exemplary predefined naming convention. Said predefined naming convention can be applied as a very functional or conceptual module in the form of a function, structure, enumeration, type definition, macro and non-local variable is prefixed with two or three predetermined alphanumeric characters. In an example embodiment, the first two letters are always “kz” and the third one is specific to the engine layer 202, 204, 206, 208 the name belongs to. Said example embodiment is described in more detail in U.S. Provisional application 61/429,766 which is herein incorporated by reference in its entirety. In addition, through the use of further predetermined alphanumeric characters, each conceptual module is capable of being designated as being limited to specific uses or modes of use. For example, a conceptual module can be limited to use inside a source file, a conceptual module can be declared as static or a conceptual module can be limited to a predetermined public header so as to not form part of the public application programming interface (API).

The system layer 208 is further divided into a common part 246 and a platform specific part 264. The public API of the system layer 208 is completely provided on the common side 246. Whereas, the implementation of the system layer 208 is divided between both the common 246 and the specific 264 parts.

The system layer 208 comprises the following functional or conceptual components, the physical parameters of which may be operatively definable on a device or computer system during use, each of which corresponds to a functional task performed by the processor: a debug component 248 to provide error handling mechanisms and debugging, a display component 158 providing abstraction for display, window and surface management, a time component 256 providing relative system time for the engine 160 and the various applications, a wrapper component 262 having wrapping functionality for relevant parts of the ANSI-C standard library as well as the OpenGL functionality or other well known equivalent functionality, an input component 260 providing a general API for handling input devices such a mouse, a touch screen, a keyboard etc.

The core layer 206 provides the core functionality for the graphics engine 160 preferably including, for example, a debug function 234, a memory manager 236, a resource manager 244, a renderer 242 and several utilities 240.

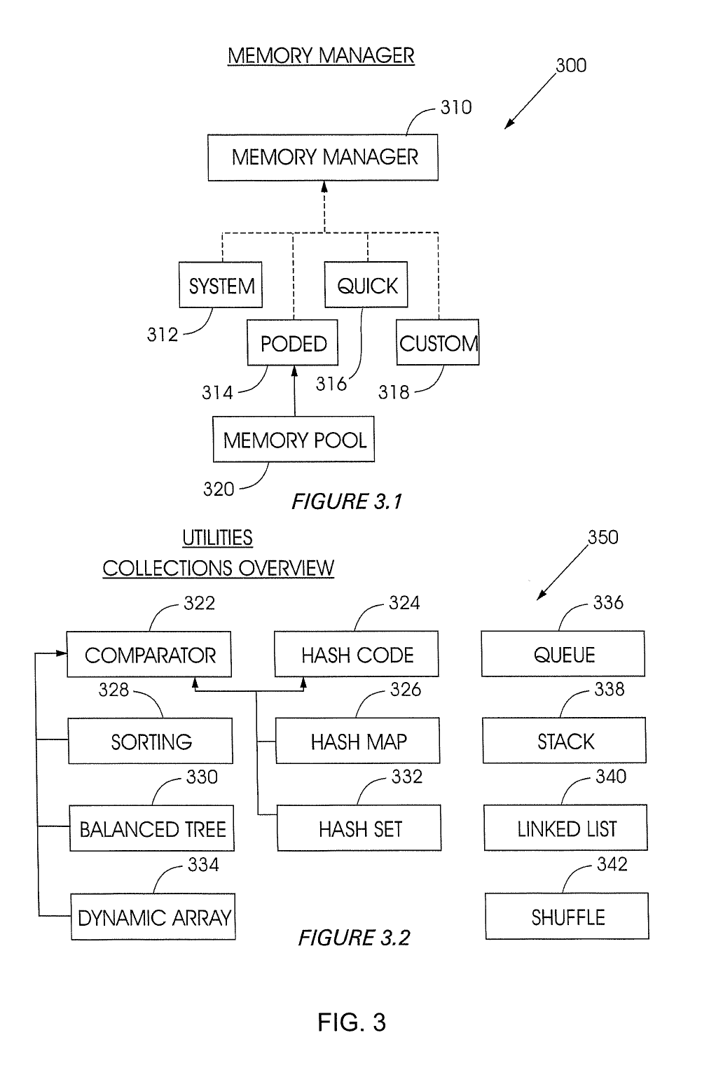

The debug function 234 provides a higher level logging mechanism than the one in the system layer 208. The memory manager 236 provides a memory manager and a memory utility. The memory manager 236 can best be described with reference to FIG. 3.1 and provides the basic memory allocation and de-allocation functions. There are four different memory manager implementations available for different purposes. These include the system memory manager 312, the pooled memory manager 314, the quick memory manager 316 and the custom memory manager 318.

The system memory manager 312 is a simple memory manager that allocates memory directly from the system memory using standard library functions. The pooled memory manager 314 consists of multiple memory pools and the logic for handling them. Here, the memory for the pools is pre-allocated during initialization of the manager. Similarly, the quick memory manager 316 also pre-allocates the memory during initialization. However, de-allocations of single blocks is not supported at all.

With the custom memory manager 318 there is an interface for application specific memory management.

The renderer 242 in the core layer 206 works as a proxy between the user layer 204 or application and the actual implementation of the system. The resource manager 244 is preferably used for hiding resource data structures and other implementation details.

The utilities component 240 in the core layer 206 provides general purpose functionality for the graphic engine 160 and applications. The utilities function works with the memory manager to ensure that minimal interaction is required from the user with regard to the memory requirements of the utilities.

An example of the collection utilities 350, is described with reference to FIG. 3.2. Here the comparator 322 provides a specific call-back function which calculates the natural order of two objects of a specific type. Hash-code 324 is a single call-back function, which calculates the hash-code of a given object of a specific type. The sorting component 328 provides some basic functions for sorting arbitrary arrays. In turn, the shuffle component 342 provides for the shuffling of arbitrary arrays. The dynamic array 334 is a linear data structure which automatically allocates enough memory to hold all inserted elements. The balanced tree 330 is a binary search tree, which automatically balances itself to provide guaranteed fast operations. The hash map 326 provides a mapping data structure and the hash set 332 provides a set data structure. The linked list 340 provides a doubly-linked list structure and the queue 336 is a wrapper API over the linked list 340 which provides queue operations. Similarly, stack 338 is a linked list 340 which provides stack operations.

The user layer 204 is a high level API for the graphics engine 160.

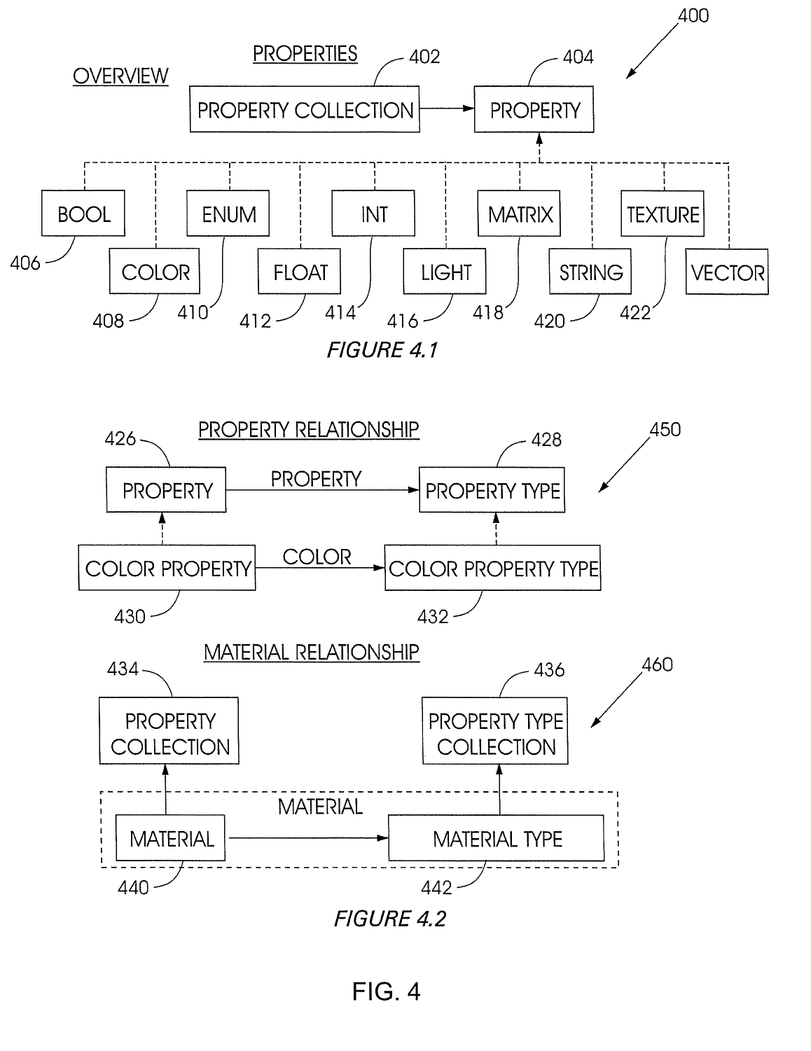

With reference to FIG. 4.2, the properties 404 are containers for different types of values with a common interface. This interface allows properties to be used in several places in the engine 160 including the scene graph and materials. The property collection 402 is a container for holding an arbitrary number of properties 404. Most of the property implementations are containers for basic primitives or structures such as Booleans 306, floats 412, colours 408, enumerations 410 and integers 414. Some properties have additional information, such as texture 422 includes information about the texture unit for which the texture applies as well as the texture combine operation, the string 420 contains information about the character string to which it relates, the light 416 property type is a collection of shading properties and an optional light reference.

With reference to FIG. 4.2, the utilities module 450 provides the general purpose functionality for the engine 160 and applications. All of the utilities work together with the memory manager 236 to ensure that minimal interaction is required from the user with regard to the memory requirements of the utilities.

In addition, with reference to FIG. 4.2, material like properties is divided into two structures called material 440 and material type 442. In a similar manner as property type 426 describes what a single property 426 is like, material type 442 describes what a single material 440 is like. Material 440 consists of a property collection 434 and material-type consists of a property-collection 436.

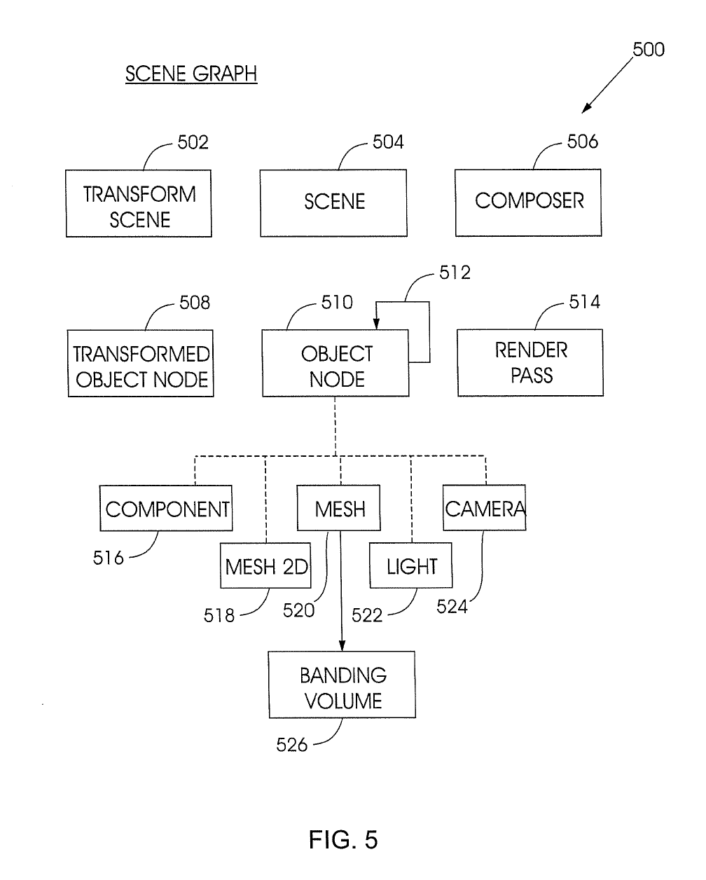

With reference to FIG. 5, a scene graph 500 is depicted showing a graph structure for an entire scene 504 and all the nodes liked to it. A typical scene contains a root object node 510, a couple of mesh nodes 520 under it, one or more light nodes 522, one or more camera nodes 524, and a composer 506 with one or more render passes 514.

The scene graph 504 includes a root object node 510, scene properties, scene view camera and active composer. In addition, the object node 510 is a super class for different types of scene graph nodes. Before rendering a scene, transformed object nodes 508 are created for every instance of object node in the scene graph 500. A component 516 is an object type of four interface elements. Mesh 520 is a type of object, which holds data of a polygonal three-dimensional model. In addition, the bounding volume 526 is a primitive shape surrounding the three-dimensional model of mesh 520.

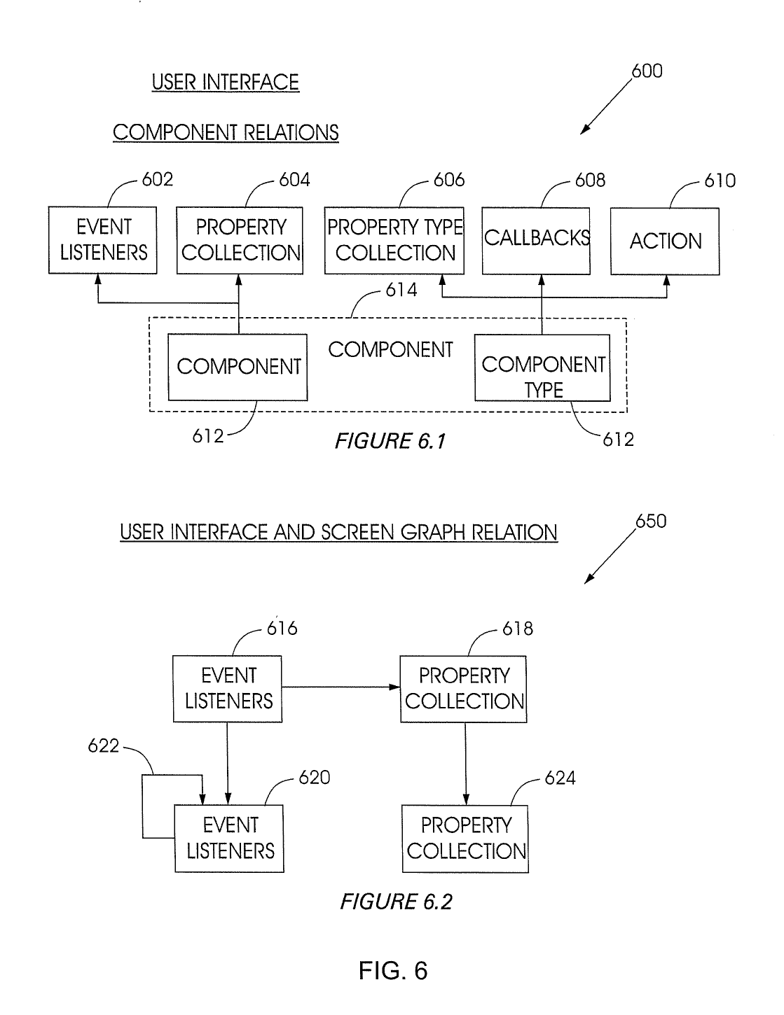

With reference to FIGS. 6.1 and 6.2, the user interface component 600 provides a graphical user interface implementation for applications. The user interface 600 keeps track of user interface components and synchronizes them to the scene 400.

User interface components are formed from two structures component 616 and component type 612. The component type 612 defines how the component 616 behaves and what properties it is required to have. Each component 616 is linked to a component type 612. Component type 612 also provides the logic for the component and the actions 610 the component can have.

A component 614 is an implementation of a component 616 described by the component type 612. The component 614 can be added to the scene graph as a components node. Event listeners 608 can be attached to components 616, which forward events from the component 616 to other components or to user specific functions.

The engine 160 contains an animation component 714, which drives the animation of a scene. With animation component it is possible to animate the properties 716 of objects like objects position, light settings, colours and shader parameters.

Each scene preferably contains an animation player 702, which handles the animation playback. The playback settings, like speed and playback mode, can be adjusted independently for each animated item with time line entry 706 structure. The animation structure is a collection of animation keys 714. Animation clip 710 can be used to select subsets from animations.

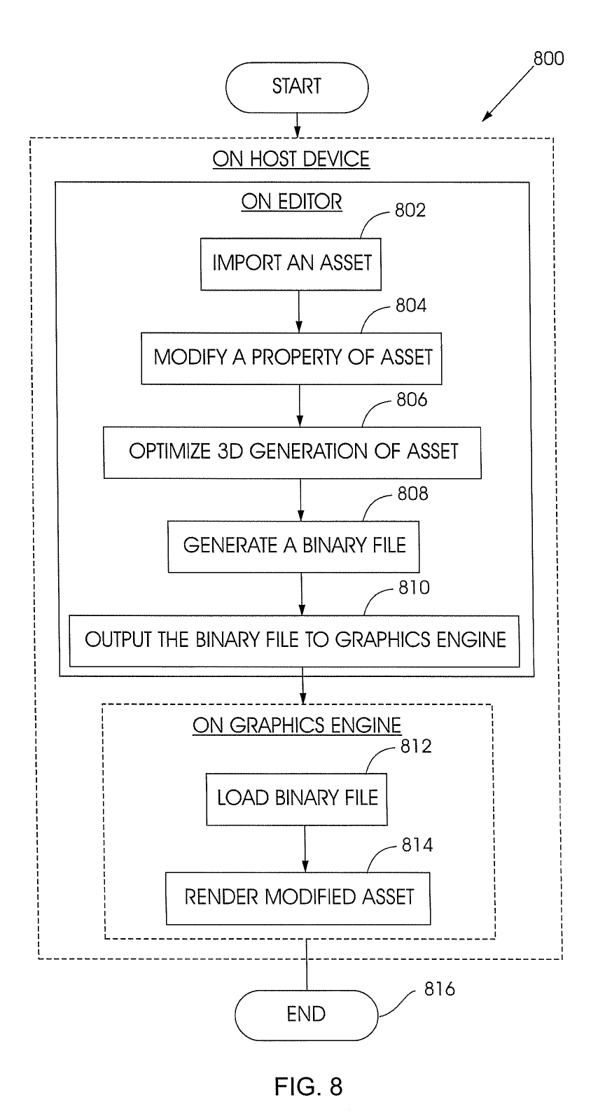

With reference to FIG. 8, a method of generating a graphical user interface for an embedded device is generally indicated by reference numeral 800.

On a host device, at block 802, at least one asset is imported into an editor on the device. Assets are preferably fully three-dimensional, though they may be representable as two-dimensional objects. However, as an example, the logic and visualization of the assets is preferably done directly in three-dimensional space, i.e. there is preferably no 2D to 3D conversion of assets and/or asset properties. Assets themselves can be, for example, three-dimensional user interface components such as buttons, sliders, list boxes, cursors, backgrounds, icons, tools, interactive figures, graphical objects and graphical representations of objects. Furthermore, examples of modifiable properties are: size, shape, color, shading, movement, shadow, orientation, function, location, appearance, file byte size and asset name. One of ordinary skill in the art will recognize that this is not an exhaustive list of assets and properties and the present invention should not be limited as such. Merely, they are meant as examples of assets and properties from which one of ordinary skill in the art will recognize countless similar and alternative examples falling within the scope of the present invention.

At block 804, when the user graphically effects modifications to the properties of the imported asset, the properties of the imported asset are automatically modified by the editor for optimal three-dimensional generation of the asset on the user interface, at block 806. When said at least one asset is a three-dimensional asset, a modification of said at least one asset in said editor can be a modification of only a first two dimensions of said three-dimensional asset. As such, a modification of said third dimension of said three-dimensional asset is a modification which is independent of a user of said device.

At block 808, a binary output file is generated including the modified asset which conforms to a predefined file naming convention. At block 810, The generated output file is then outputted to a graphics engine within the editor which is capable of loading the file as an endian independent, at block 812, and rendering the file as at least a portion of a three-dimensional user interface on an embedded device, at block 814.

In this respect, the endian independence of file loading and rendering refers to the ordering of data being independent of the degree of significance of individually accessible data within the output file. As such, new files, e.g. updated assets, can be added to the end of a larger file accessible by the graphics engine and supersede previously stored files and/or sub-files.

Loading said binary file can include loading the binary file into a graphics engine within the editor. This can additionally be independent of a degree of significance of individually accessible data within said output file, prior to outputting said binary file to said graphics engine. The step of rendering the modified asset can include rendering said asset within a three-dimensional user interface in said editor, prior to outputting said binary file to said graphics engine. The loading and rendering of the binary output file can also take place by means of a predetermined application programming interface (API).

The binary output file can be rendered to either a virtual or a physical display. The virtual display can be provided in the form of a user interface, wherein said user interface interacts in an identical manner to said physical display. Furthermore, there can additionally be a further step of re-generating one or more of the binary output file(s) of an asset, or further modified asset, in order to check, determine or create conformance to a predefined file naming convention. Said predefined file naming convention can be as described above.

The binary output file can further be provided in the form of a set of files. As such, said set of files can includes a configuration file, a standalone file, a list of patch files or a combination thereof. A configuration file can be, for instance, provided in a simple format and contain a number of file paths, each of said file paths being relative to a working directory of an application using said configuration file. A method as such can further comprises the step of applying a patch file or list of patch files on top of one or more standalone file(s) so as to create a data container, wherein said data container is therefore capable of being patched further.

A patch file in within a list of patch files is operable to add, replace and/or delete one or more assets from said standalone file. The patch file can be generated by exporting one or more standalone file(s), comparing said one or more standalone file(s) to one or more base file(s) and saving any modifications to one or more standalone file(s) into a patch file or files(s). Any temporary standalone data in said base file can be optionally or automatically discarded.

Furthermore, there can be created a unique version of a graphical user interface development project. A unique data container can be exported from each of a plurality of profiles. The format of said exported data container can be configurable to either a standalone format or a patch format. In certain instances, a standalone format can include creating a separate file from each profile in said plurality of profiles whereas said patch format can include using a base file and creating a separate configuration and patch file for each profile in said plurality of profiles.

A number of examples for the use and operation of the present method and system have been presented herein. These examples are not meant to be limiting in nature but to help explain the concepts and exemplary operation of the methods and systems. For example, the graphics engine 160 enables UI designs to be easily executed on any device supporting graphics API. While such API's have been described herein such as OpenGL ES 2.0 and OpenGL ES 1.x, other versions of OpenGL or DirectX, one of ordinary skill in the art will recognize that the present invention is not limited to those formats or even to just other clear art recognized equivalents. The present invention can, for instance, be implemented alongside other art recognized CPU rendering alternatives to those listed above. As such, those of ordinary skill in the art will recognize countless variations not explicitly enumerated which do not part from the scope of the present invention.

1. A method of generating a three-dimensional user interface on at least one embedded device, said method comprising the steps of:
importing at least one asset into an editor on a host device;
in response to graphically effecting modifications, within said editor, to at least one property of the asset for the three-dimensional user interface, modifying to at least one property of said imported asset independently of a user of said host device, so as to optimize a three-dimensional generation of said asset on an embedded device within said editor;
generating a binary output file of said modified asset conforming to a predefined file naming convention; and
outputting said binary file to a graphics engine, said graphics engine being operable to load and render said file as at least a portion of a graphical user interface on said embedded device prior to outputting said binary file,
wherein ordering of data in said binary output file is independent of a degree of significance of individually accessible data within said output file.

2. (canceled)

3. A method as claimed in claim 1, wherein the step of loading said binary file includes loading the binary file into said graphics engine within said editor independently of a degree of significance of individually accessible data within said output file, prior to outputting said binary file to said graphics engine.

4. A method as claimed in claim 1, wherein the asset is a three-dimensional asset and wherein the step of rendering said modified asset includes rendering said asset within a three-dimensional user interface in said editor, prior to outputting said binary file to said graphics engine.

5. A method as claimed in claim 1, wherein the step of loading and rendering said binary output file takes place by means of a predetermined application programming interface (API) and wherein said binary output is rendered to either a virtual or a physical display provided in the form of a user interface, said user interface interacting in an identical manner to said physical display, or to a physical display.

6. (canceled)

7. (canceled)

8. A method as claimed in claim 1, wherein said method further comprises the step of:
re-generating a binary output file of said further modified asset conforming to a predefined file naming convention.

9. A method as claimed in claim 1, wherein said predefined file naming convention includes at least one engine layer component identifying a graphics engine layer to which said binary file is to belong and wherein said file naming convention further includes an individual component identifying a non-version specific asset.

10. (canceled)

11. (canceled)

12. (canceled)

13. (canceled)

14. A method as claimed in claim 4, wherein a modification of said at least one asset in said editor, is a modification of only a first two dimensions of said three-dimensional asset.

15. A method as claimed in claim 14, wherein a modification of said third dimension of said three-dimensional asset is a modification which is independent of a user of said device.

16. A method as claimed in claim 1, wherein said at least one asset is selected from a group including: buttons, cursors, backgrounds, icons, tools, interactive figures, graphical objects and graphical representations of objects.

17. A method as claimed in claim 1, wherein said at least one property is selected from a group including: size, shape, colour, shading, movement, shadow, orientation, function, location, appearance, file byte size and asset name.

18. A method as claimed in claim 1, wherein said binary output file is provided in the form of a set of files including at least a configuration file, a standalone file and a list of patch files.

19. (canceled)

20. (canceled)

21. A method as claimed in claim 18, wherein said method further comprises the step of applying said list of patch files on top of said standalone file so as to create a data container, said data container being operable to be patched further.

22. (canceled)

23. (canceled)

24. (canceled)

25. A method as claimed in claim 1, wherein said method further comprises the step of creating a unique version of a graphical user interface development project, wherein a unique data container is exported from each of a plurality of profiles.

26. (canceled)

27. (canceled)

28. (canceled)

29. A system for generating a three-dimensional user interface for at least one embedded device, said system comprising:
a graphics design editor operable to create and customize a graphical user interface on an embedded device; and
a graphics generation engine including a plurality of layers, each of said plurality of layers being ranked in order from lowest to highest as follows: an application framework layer, a user layer, a core layer, and a system layer, each of said plurality of layers only being dependent on a layer immediately preceding said layer in rank.

30. A non-transitory computer-readable medium having stored thereon a set of computer readable instructions for causing a computer system to perform a method of generating a three-dimensional user interface on at least one embedded device, said method comprising the steps of:
importing at least one asset into an editor on a host device;
in response to graphically effecting modifications, within said editor, to at least one property of the asset for the three-dimensional user interface, modifying to at least one property of said imported asset independently of a user of said host device, so as to optimize a three-dimensional generation of said asset on an embedded device within said editor;
generating a binary output file of said modified asset conforming to a predefined file naming convention; and
outputting said binary file to a graphics engine, said graphics engine being operable to load and render said file as at least a portion of a graphical user interface on said embedded device prior to outputting said binary file,
wherein ordering of data in said binary output file is independent of a degree of significance of individually accessible data within said output file.

31. (canceled)
